(19) United States
(12) Patent Application Publication
(10) Pub. No.: US 2005/0035554 A1
(43) Pub. Date: Feb. 17, 2005

(54) Damper device for mechanical seals

(76) Inventors: Tom Roberts, Sheffield (GB); Chris Booth, Sheffield (GB)

Correspondence Address: MYERS BIGEL SIBLEY & SAJOVEC, PO BOX 37428, RALEIGH, NC, 27627, US

(21) Appl. No.: 10/856,486

(22) Filed: May 28, 2004

(30) Foreign Application Priority Data
May 28, 2003 (GB) GB0312185.2

(51) Int. Cl. F16J 15/34

(52) U.S. Cl. 277/358

(57) ABSTRACT

A damper device for a mechanical seal includes support means arranged relative to a seal face assembly or a gland plate of the mechanical seal such that a predetermined gap is formed between the support means and the seal face assembly/gland plate and also includes damping means disposed in the predetermined gap in order to reduce the transmission of noise produced by the mechanical seal.

### RELATED APPLICATION

This application claims priority to UK Patent Application No. GB0312185.2, filed May 28, 2003, the disclosure of which is hereby incorporated herein by reference.

### FIELD OF INVENTION

This invention relates to damper devices for mechanical seals and mechanical seals comprising such damper devices. The invention particularly relates to damper devices for absorbing noise produced by the mechanical seals, for example noise produced by the seal faces of the mechanical seals due to poor lubrication conditions.

### BACKGROUND INFORMATION

A mechanical seal comprises a “floating” component and a “static” component. The floating component has a flat annular end face, i.e. a seal face that is directed towards a complementary seal face of the static component. The components are urged together, usually by means of one or more spring members, in order to close the seal faces together to form a sliding seal.

When a mechanical seal is in use then either the floating or static component rotates. The rotating component is usually referred to as the “rotary component” and its seal face is referred to as the “rotary seal face”. The non-rotating component is referred to as the “stationary component” and its seal face is referred to as the “stationary seal face”.

The mechanical seals in which the floating component is rotary are often described as “rotary seals”. However, if the floating component is stationary then the mechanical seal is commonly described as a “stationary seal”.

If the rotary and stationary components are pre-assembled and pre-set prior to despatch from the manufacturing premises then these types of mechanical seals are known as “cartridge seals”. Alternatively, if the rotary and stationary components are despatched individually (unassembled) from the seal manufacturing premises, then the mechanical seal is known as a “component seal”.

Mechanical seals are used to seal a variety of different process media. The general industry term which defines the area of the mechanical seal that is adjacent the process media is “inboard” and the term which defines the area adjacent the atmospheric side is “outboard”.

Mechanical seals are used in a wide variety of industrial applications and operating conditions. Typically, mechanical seal faces require a fluid film to both lubricate and cool them during operation. In mechanical seals with a single seal configuration the fluid film is usually the process media and this may be a gas or liquid. In a dual seal application, the fluid film may be either process media or a secondary fluid known as a buffer or barrier fluid. Secondary fluids are usually a gas maintained at a higher pressure than the process fluid.

A number of conditions determine the nature and effectiveness of the fluid film between the seal faces and these include sealing pressure, seal face geometry and seal face balance. The lubricating properties of the fluid film are also important. It has been found that a gas film is a poorer lubricant than a liquid fluid film and results in a thinner fluid film between the seal faces of a seal.

Fluid films that provide very little lubrication between the seal faces and a high pitch squeaking sound often occurs. The noise is undesirable and is most uncomfortable to a user of the equipment that incorporates a mechanical seal.

Therefore it would be advantageous to in some way reduce the volume of the noise generated from the seal faces, particularly when they are operating in poor fluid film conditions.

Embodiments of the invention seek to overcome this problem by providing means to minimise the transmission of the noise. The means are sufficient to at least reduce the level of noise and may even prevent any noise from being transmitted.

A first aspect of the invention provides a damper device for a mechanical seal having a seal face assembly, the damper device comprises support means arranged relative to the seal face assembly such that a predetermined gap is formed between the support means and the seal face assembly and also comprises damping means disposed in the predetermined gap in order to minimise the transmission of noise produced by the mechanical seal.

Preferably, the support means are arranged relative to a rotary seal face assembly.

Preferably, the support means are arranged relative to a stationary seal face assembly.

The support means may be arranged relative to a radial outer surface of the seal face assembly and/or arranged relative to an axial outer surface of the seal face assembly.

A second aspect of the invention provides a damper device for a mechanical seal having a gland plate, the damper device comprises support means arranged relative to the gland plate such that a predetermined gap is formed between the support means and the gland plate and also comprises damping means disposed in the predetermined gap in order to minimise the transmission of noise produced by the mechanical seal.

Preferably, the damper device of the first and second aspects of the invention include damping means comprising an elastomeric material suitable for absorbing noise. In this case, the damping means may comprise an O-ring.

Preferably, the damper device of the first and second aspects of the invention includes damping means comprising a plastic material suitable for absorbing noise.

The damper device of the first and second aspects of the invention may include damping means that comprise a lip-type seal.

Also, the damper device of the first and second aspects of the invention may include damping means comprising a damping fluid that is suitable for absorbing noise or a vacuum that minimises the transmission of noise.

The damper device of the first and second aspects of the invention may include support means that comprise a non-metallic material suitable for absorbing noise.

A third aspect of the invention provides a mechanical seal comprising a damper device according to the first or second aspect of the invention.

### BRIEF DESCRIPTION OF DRAWINGS

For a better understanding of the present invention and to show how it may be carried into effect, reference shall now be made by way of way of example to the accompanying drawings, in which:

FIG. 1 depicts a sectional view of the first embodiment of the first aspect of the present invention arranged within a conventional rotary mechanical seal.

FIG. 2 depicts an enlarged sectional view of the first embodiment of first aspect of the present invention.

FIG. 3 depicts a second embodiment of the first aspect of the invention arranged with respect to a rotating external pusher seal face assembly within a mechanical seal with a single seal configuration.

FIG. 4 depicts a third embodiment of the first aspect of the invention where two damper devices are arranged with respect to the rotary seal face assembly and the stationary seal face assembly of a mechanical seal with a single seal configuration.

FIG. 5 depicts a fourth embodiment of the first aspect of the invention arranged with respect to a metal bellows rotary seal face assembly.

FIGS. 6a and 6b depicts a fifth embodiment of the first aspect of the invention arranged with respect to a monolithic, non-shrunk fitted seal face.

FIG. 7 depicts a sixth embodiment of the first aspect of the invention arranged with respect to a rotary seal face assembly.

FIG. 8 depicts a seventh embodiment of the first aspect of the invention arranged with respect to a rotary seal face assembly.

FIG. 9 depicts an eighth embodiment of the first aspect of the invention arranged with respect to a rotary seal face assembly

FIG. 10 depicts an embodiment of the second aspect of the invention arranged with respect to a gland plate of a static component.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. As used herein, the term “and/or” includes any and all combinations of one or more of the associated listed items.

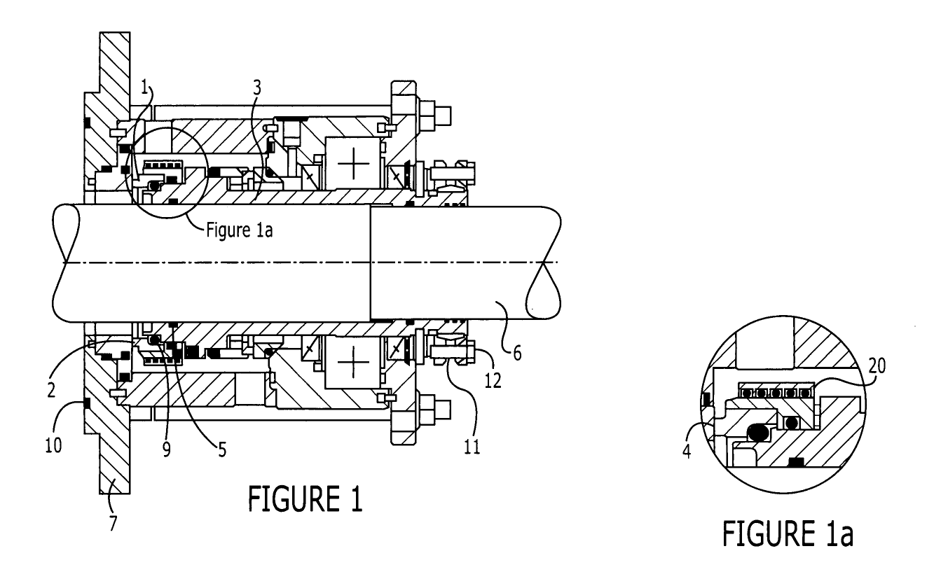

FIG. 1 depicts a sectional view of a conventional double seal, rotary mechanical seal where a rotary seal face (1) is spring biased towards a stationary seal face (2). In this case the rotary seal face (1) is the seal face of a floating component that is axially mounted to the sleeve (3) and the stationary seal face (2) is the seal face of a static component that is axially mounted to the housing of the seal. The rotary seal face (1) is allowed to slide on the stationary seal face (2). The interface between the rotary seal face (1) and stationary seal face (2) forms sealing area (4). This sealing area (4) is the primary seal that prevents the process media from escaping from the process chamber.

The process media is also sealed by further secondary sealing areas. A first secondary sealing area is formed between a sleeve elastomer (5) in contact with the shaft (6) and sleeve (3). A second secondary sealing area is formed between stationary seal face (2) and stationary gland (7) using elastomer (8). A third secondary sealing area is formed between the rotary seal face (1) and the sleeve (3) using elastomer (9). A fourth secondary sealing area is formed between the gland (7) and the process chamber (not shown) using elastomer (10). A clamp ring assembly (11) contains a screw (12) that secures the sleeve (3) to the shaft (6) so that rotational drive from the shaft (6) is transmitted to the sleeve (3). Said rotational drive is transmitted to the rotary seal face (11) by at least one drive mechanism.

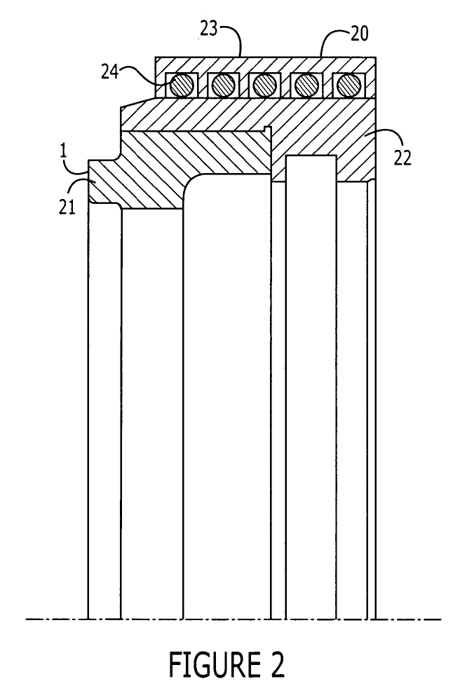

FIG. 1 also depicts a first embodiment of a damper device (20) that is arranged with respect to the rotary seal face assembly. Here the rotary seal face assembly includes a rotary seal face component (21) with a rotary seal face (1) and a rotary seal face component holder (22). An enlarged view of the damper device (20) is depicted in FIG. 2. The first embodiment of the damper device (20) may alternatively be positioned with respect to the stationary seal face assembly.

The damper device (20) includes a support member (23) and damping means (24). The support member (23) is arranged such that it is separated from a surface of the rotary seal face assembly in order to form at least one predetermined gap. Damping means (24) are located within the predetermined gap. A plurality of damping means (24) may be disposed within a plurality of gaps. A damper device may include a variety of different damping means (24) to reduce the transmission of the noise produced by the seal faces of a mechanical seal. The support member serves to support the damping means and help retain it in place. The damping means may serve to secure the support member in position with respect to the seal face assembly. In this case, the support member is radially spaced apart from the outer surface of the rotary seal face component holder (22) and a plurality of predetermined gaps are formed. Damping means are arranged within each gap formed between the support member (23) and the surface of the seal face assembly.

The damping means may be formed from an elastomeric material such as rubber, VITON or KAREZ as supplied by Dupont Dow elastomers, AFLAS as supplied by Asahi Glass Co., NITRILE or EPR/EPDM. The damping means may comprise at least one elastomeric O-ring. In this particular embodiment the dampening means (24) consist of five elastomeric O-rings that extend circumferentially between the outer radial surface of the rotary seal assembly and under the inner radial surface of the support member. Alternatively, the damping means may be formed from a plastic material such as TEFLON or a gasket material such as AFI may be used. Damping means formed from an elastomeric or plastic material act as energy absorbers and absorb noise produced by a mechanical seal.

The support member may be formed from a metallic and/or non-metallic material. The support member may be formed from elastomeric materials and/or plastic materials that are suitable for absorbing noise and so further help in reducing the transmission of noise produced by the mechanical seal.

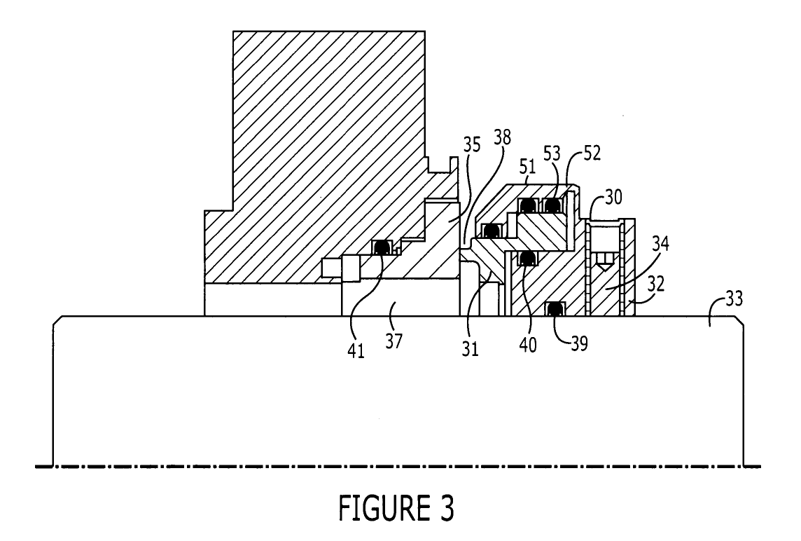

FIG. 3 depicts a mechanical seal with a single seal configuration comprising a rotating external pusher seal face assembly (30). This seal face assembly consists of a seal face component (31) that is radially supported by a clamp ring (32) that is in turn secured to a rotating shaft (33) by at least one set screw (34). The axially floating seal face component (31) rotates with the shaft (33) and forms a sliding surface with the stationary seal face component (35) which is axially static with the equipment housing. The process media (37) is sealed by the sliding interface (38), the clamp ring elastomer (39), the rotary seal face elastomer (40) and the stationary seal face elastomer (41).

The support member (52) of the damper device (51) is arranged radially with respect to the outer surface of the rotary seal face component (31) and a plurality of elastomeric O-rings (53) are disposed within the predetermined gaps.

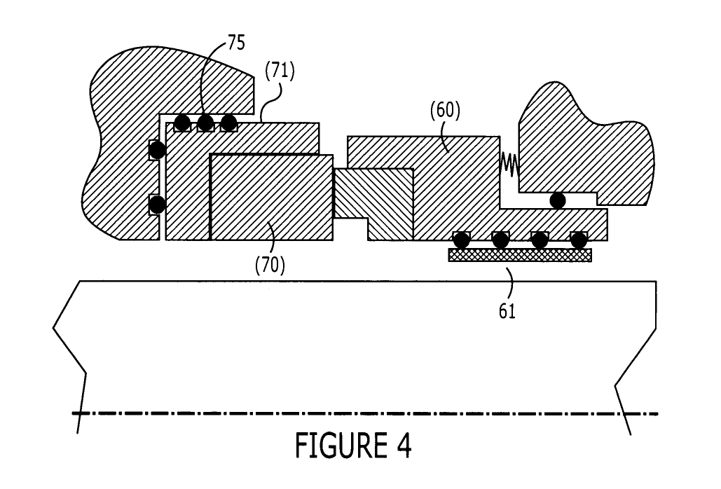

FIG. 4 shows another mechanical seal with a single seal configuration where a damper device (61) is mounted on the inside diameter of the rotary seal face assembly (60) and a further damper device (71) is arranged relative to the radial surface (75) of a stationary seal face assembly (70). In this particular embodiment the damping means are O-rings. The support member of the damper device (61) mounted with respect to the rotary seal face assembly (60) may be the sleeve of the mechanical seal. Furthermore, the support member of the damper device (71) arranged relative to the stationary seal face assembly may be the gland plate of the mechanical seal.

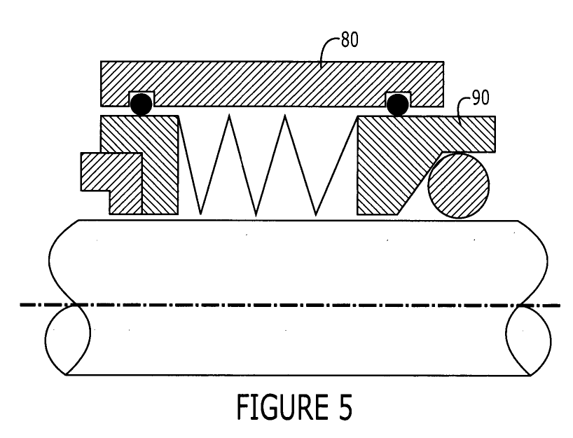

FIG. 5 depicts a damper device (80) mounted with respect to a metal bellows rotary seal face assembly (90).

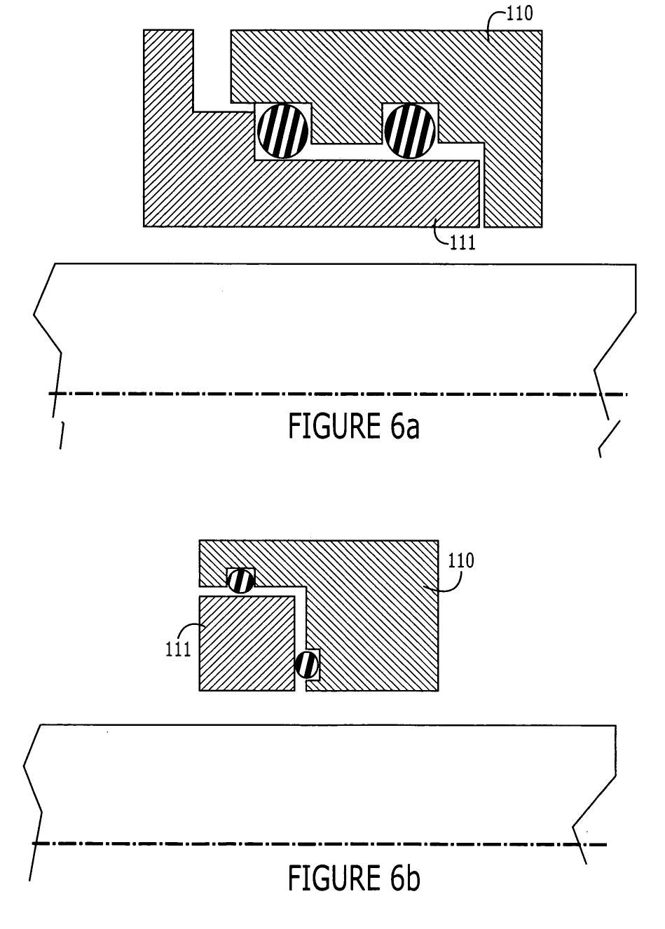

FIG. 6a depicts an embodiment of the invention where the support member (110) is spaced apart from a monolithic, non-shrunk fitted seal face (111). O-rings, positioned within the predetermined gaps, contact both the outer radial surface of the seal face and inner surface of the support member. FIG. 6b depicts an embodiment where the support member (10) is spaced apart from both the axial and radial surfaces of a monolithic, non-shrunk fitted seal face (111). In this case, the seal face assembly comprises merely a monolithic, non-shrunk fitted seal face. The monolithic seal faces may be a monolithic stationary seal face or a monolithic rotary seal face.

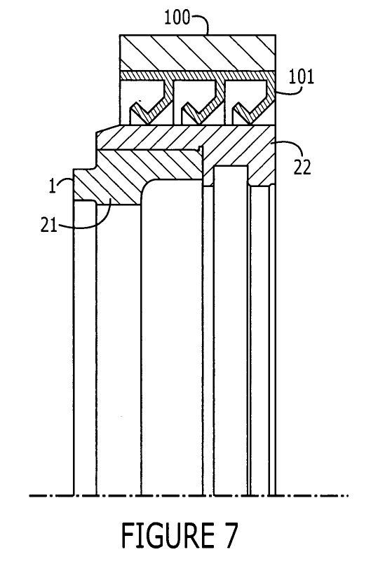

FIG. 7 depicts a further embodiment of the invention where a support member (100) is spaced from a rotary seal face component holder (22) to form a predetermined gap in which at least one lip-type seal (101) is disposed. The lip-type seals are positioned so that they can absorb noise unwanted noise produced. In the example shown, three lip-type seals (101) are located in the predetermined gap. The lip-type seals (101) are mounted radially with respect to the outer surface of the seal face assembly. The lip-type seals are supported by the support member. Such a damper device may be arranged with respect to a stationary seal face.

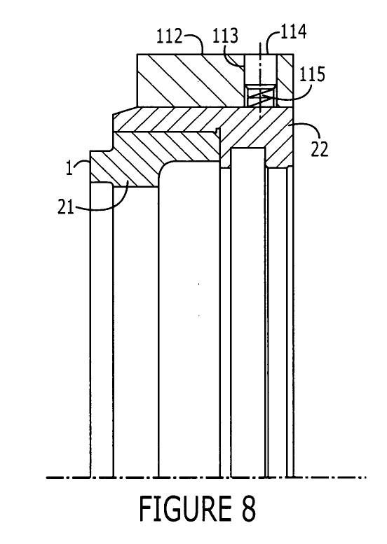

FIG. 8 shows a seventh embodiment of the invention where a support member (112) includes a least one orifice (113) that extends entirely through the support member. The orifice is shaped to allow a set screw (114) to be inserted. The orifice is preferably threaded. The support member is arranged relative to a surface of the rotary seal face component holder (22) such that a predetermined gap is formed between the set screw (114) and the surface of the holder. Damping means in the form of a spring-like member (115) are disposed in the predetermined gap. The spring-like member acts as an energy absorber and is suitable for absorbing noise. Obviously this embodiment of the damper device is suitable for use with a stationary seal face assembly.

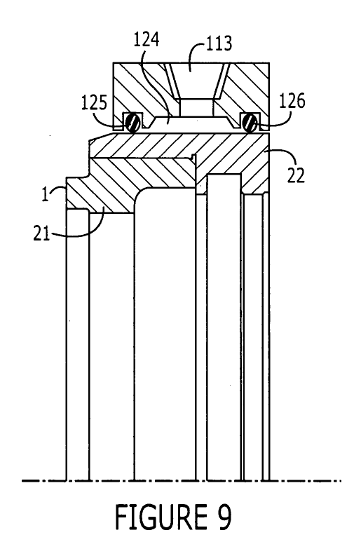

FIG. 9 depicts yet another embodiment of the present invention arranged with respect to a rotary seal face assembly. The eighth embodiment of the invention comprises a support member that includes an orifice (113) through which fluid may flow to and from a predetermined gap. Accordingly, the gap (124) may be filled with a damping fluid to absorb noise. Alternatively fluid may be removed from the gap in order to create a vacuum that prevents the transmission of noise produced by the mechanical seal. Further predetermined gaps are formed within which elastomers (125 & 126) are disposed. The elastomers are used to help seal the predetermined gap containing the damping fluid or vacuum and help further absorb noise. This embodiment may be mounted relative to a stationary seal face assembly.

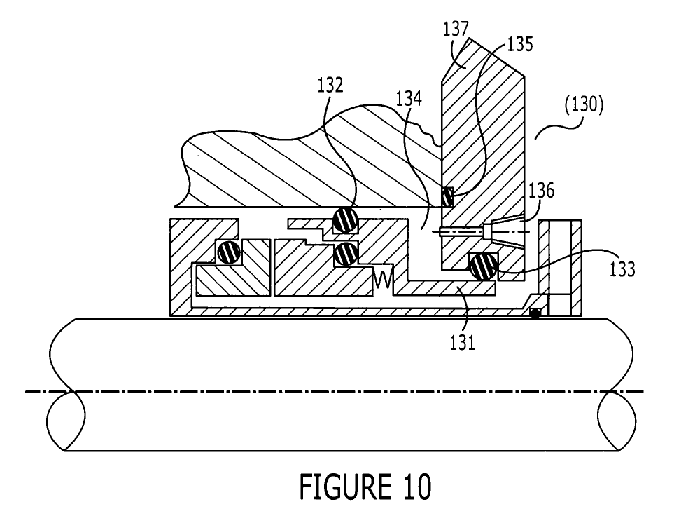

FIG. 10 depicts a cartridge seal in which an embodiment of a second aspect of the invention is mounted. In this particular example the support member of the damper device is not arranged with respect to a seal face assembly but with respect to a gland plate of a static component. As with the embodiments of the first aspect of the invention, the damping means may be formed from an elastomeric material, plastic material or damping fluid, they may comprise a lip-type seal or alternatively be formed by a vacuum. The damper device may incorporate a single or plurality of similar or different damping means. The support member may be formed from metallic and/or non-metallic materials such as an elastomer and/or plastic. In FIG. 10 the support member is a stationary gland insert damper (131) that is arranged to form a radially and axially extending gap (134) between it and a gland plate (137). The gap may be filled with damping fluid or a vacuum may be created using an orifice (136) formed in the gland plate (137). Further predetermined gaps are formed in which elastomers (132, 133 and 135) are arranged to help seal the former gap and further absorb noise. The gland insert damper (131) may be formed from a plastic material to help further reduce the noise produced by the sliding seal faces.

It is evident that the invention may be arranged relative to both rotary and stationary seal face assemblies and also the gland plate. Damper devices may be arranged radially and/or axially with respect to the seal face assemblies and gland plates. The damping means may be formed from a variety of materials or it may be a vacuum. A damper device may include a plurality of damping means and may include a plurality of different types of damping means. Furthermore, the invention may be used within both rotary and stationary mechanical seals, mechanical seals with single, double or triple seal configurations, metal or rubber bellow seals, pusher seals and also cartridge seals or component seals.

Many variations and modifications can be made to the preferred embodiments without substantially departing from the principles of the present invention. All such variations and modifications are intended to be included herein within the scope of the present invention, as set forth in the following claims.

1. A damper device for a mechanical seal having a seal face assembly, the damper device comprising:
support means arranged relative to the seal face assembly such that a predetermined gap is formed between the support means and the seal face assembly; and
damping means disposed in the predetermined gap in order to reduce the transmission of noise produced by the mechanical seal.

2. A damper device according to claim 1 wherein the support means are arranged relative to a rotary seal face assembly.

3. A damper device according to claim 1 wherein the support means are arranged relative to a stationary seal face assembly.

4. A damper device according to claim 1 wherein the support means are arranged relative to a radial outer surface of the seal face assembly.

5. A damper device according to claim 1 wherein the support means are arranged relative to an axial outer surface of the seal face assembly.

6. A damper device according to claim 1 wherein the damping means comprises an elastomeric material suitable for absorbing noise.

7. A damper device according to claim 6 wherein the damping means comprise an O-ring.

8. A damper device according to claim 1 wherein the damping means comprises a plastic material suitable for absorbing noise.

9. A damper device according to claim 1 wherein the damping means comprises a lip-type seal.

10. A damper device according to claim 1 wherein the support means comprises an orifice through which fluid may flow to or from the predetermined gap.

11. A damper device according to claim 10 wherein the damping means comprises a damping fluid that is configured to absorb noise and flows into the predetermined gap through the orifice in the support means.

12. A damper device according to claim 10 wherein the damping means comprises a vacuum that reduces the transmission of noise and is created as fluid flows from the predetermined gap through the orifice in the support means.

13. A damper device according to claim 1 wherein the support means comprises an orifice that extends through the support means and a set screw inserted in the orifice whereby the predetermined gap is formed between the set screw and seal face assembly; and
wherein the damping means comprises a spring-like member that is configured to absorb noise and is disposed in the predetermined gap.

14. A damper device according to any of claim 1 wherein the support means comprises a non-metallic material configured to absorb noise.

15. A damper device for a mechanical seal having a gland plate, the damper device comprising:
support means arranged relative to the gland plate such that a predetermined gap is formed between the support means and the gland plate; and
damping means disposed in the predetermined gap in order to reduce the transmission of noise produced by the mechanical seal.

16. A damper device according to claim 15 wherein the support means comprises a stationary gland insert damper.

17. A damper device according to claim 15 wherein the support means are arranged radially relative to the gland plate.

18. A damper device according to any of claim 15 wherein the support means are arranged axially relative to the gland plate.

19. A damper device according to any of claim 15 wherein the damping means comprises an elastomeric material configured to absorb noise.

20. A damper device according to claim 19 wherein the damping means comprises an O-ring.

21. A damper device according to claim 15 wherein the damping means comprises a plastic material configured to absorb noise.

22. A damper device according to claim 15 wherein the damping means comprises a lip-type seal.

23. A damper device according to claim 15 wherein an orifice extends through the gland plate such that fluid may flow to or from the predetermined gap.

24. A damper device according to claim 23 wherein the damping means comprises a damping fluid that is configured to absorb noise and flows into the predetermined gap through the orifice in the gland plate.

25. A damper device according to claim 24 wherein the damping means comprises a vacuum that reduces the transmission of noise and is created when fluid flows from the predetermined gap through the orifice.

26. A damper device according to claim 15 wherein the support means comprises a non-metallic material suitable for absorbing noise.

27. A mechanical seal comprising:
a seal face assembly; and
a damper device, comprising:
support means arranged relative to the seal face assembly such that a predetermined gap is formed between the support means and the seal face assembly; and
damping means disposed in the predetermined gap in order to reduce the transmission of noise produced by the mechanical seal.

28. A mechanical seal according to claim 27 wherein the mechanical seal is a rotary seal.

29. A mechanical seal according to claim 27 wherein the mechanical seal is a stationary seal.

30. A mechanical seal according to claim 27 wherein the mechanical seal has a single seal configuration.

31. A mechanical seal according to claim 27 wherein the mechanical seal has a double seal configuration.

32. A mechanical seal according to claim 27 wherein the mechanical seal has a triple seal configuration.

33. A mechanical seal according to claim 27 wherein the mechanical seal is a bellow seal.

34. A mechanical seal according to claim 27 wherein the mechanical seal comprises a rotating external pusher seal face assembly.

35. A mechanical seal according to claim 27 wherein the mechanical seal is a cartridge seal.

36. A mechanical seal according to claim 27 wherein the mechanical seal is a component seal.

37. A mechanical seal comprising:
a gland plate; and
a damper device comprising:
support means arranged relative to the gland plate such that a predetermined gap is formed between the support means and the gland plate; and
damping means disposed in the predetermined gap in order to reduce the transmission of noise produced by the mechanical seal.

38. A mechanical seal according to claim 37 wherein the mechanical seal is a rotary seal.

39. A mechanical seal according to claim 37 wherein the mechanical seal is a stationary seal.

40. A mechanical seal according to claim 37 wherein the mechanical seal has a single seal configuration.

41. A mechanical seal according to claim 37 wherein the mechanical seal has a double seal configuration.

42. A mechanical seal according to claim 37 wherein the mechanical seal has a triple seal configuration.

43. A mechanical seal according to claim 37 wherein the mechanical seal is a bellow seal.

44. A mechanical seal according to claim 37 wherein the mechanical seal comprises a rotating external pusher seal face assembly.

45. A mechanical seal according to claim 37 wherein the mechanical seal is a cartridge seal.

46. A mechanical seal according to claim 37 wherein the mechanical seal is a component seal.
